(19) United States
(12) Patent Application Publication
(10) Pub. No.: US 2009/0025815 A1
(43) Pub. Date: Jan. 29, 2009

(54) Pipeline and Method for Manufacturing That Pipeline

(76) Inventors: Ralf Becks, Hamburg (DE); Joachim Deharde, Lentfoehrden (DE)

Correspondence Address: GREER, BURNS & CRAIN, 300 S WACKER DR, 25TH FLOOR, CHICAGO, IL, 60606, US

(21) Appl. No.: 11/922,471

(22) PCT Filed: Jun. 22, 2006
(86) PCT No.: PCT/EP2006/063451

§ 371 Date: Dec. 18, 2007

(30) Foreign Application Priority Data
Jun. 22, 2005 (EP) 10 2005 028 766.2

(51) Int. Cl. F16L 9/14

(52) U.S. Cl. 138/112; 138/148; 29/455.1; 138/153

(57) ABSTRACT

The invention concerns a pipeline 1, in particular a pipeline 1 for fuel systems in aircraft, including an inner pipe 6 and an outer pipe 4 surrounding the inner pipe.

In accordance with the invention, the inner pipe 6 is made of a metal material and/or, at least in portions, of a synthetic material and, at least in curved portions 5 of the pipeline 1, the outer pipe 4 is made of a synthetic material.

Due to the fact that the outer pipe 4 is made of a synthetic material, a significant weight reduction can be accomplished in comparison to conventional coaxial pipelines, which are made entirely of a metal material and which, due to manufacturing reasons, require a larger number of flange joints 2 and 3 in longer curved pipeline portions.

The invention also concerns a method for manufacturing such a pipeline 1, in particular a pipeline 1 for fuel systems in aircraft.

The present invention concerns a pipeline, in particular a pipeline for fuel systems in aircraft, comprising an inner pipe and an outer pipe surrounding that inner pipe.

Furthermore, the present invention concerns a method for manufacturing a pipeline, in particular a pipeline for fuel systems in aircraft, comprising an inner pipe and an outer pipe surrounding that inner pipe.

In aircraft, in particular in modern passenger aircraft, the tip of the stern typically contains an additional, turbine-powered auxiliary power unit for supplying power to electrical and air-powered devices, such as the air conditioning, the lighting and the overall electrical system of the plane.

Furthermore, a so-called trimming tank is ordinarily placed in the horizontal stabilizer. The trimming tank serves in particular to optimize the horizontal flight attitude of the plane, but it also has the auxiliary function of serving as an additional fuel tank to increase the range of the aircraft. The orientation of the plane with respect to the horizontal direction is accomplished by pumping fuel to and fro between the main tanks, which are ordinarily disposed in the wings of the aircraft, and the trimming tank. Additionally, fuel also has to be supplied to the auxiliary power unit from the main tanks.

The trimming tank and the auxiliary power unit are connected with the main tanks of the plane by at least one pipeline, which runs from the main tanks in the wings through the fuselage cell to the trimming tank in the horizontal stabilizer or the auxiliary power unit in the tip of the stern. It is also possible to provide two or more pipelines, which may be arranged in parallel.

In order to prevent uncontrolled leaking of fuel, the pipelines must be double-walled in accordance with the relevant security and aviation rules, in order to prevent accidents. Accidents are given for example by leakages in the fuel line. The gap in the double-walled pipeline is mainly for ventilation, for draining fuel that leaks uncontrollably as well as for shunting condensation water. By placing suitable sensors in the region of the gap, it is possible to detect the occurrence of fuel leaks, so that proper counter measures can be taken. The double-walled pipeline primarily offers protection against leakages, however not against serious mechanical damages from the outside, which may be caused by bursting landing gear tires, breaking landing gear wheels, exploding turbines or the like.

Conventionally, such double-walled pipelines are preferably made of stainless steel and/or aluminum. In particular to reduce weight, titanium is increasingly used in newer types of aircraft to manufacture double-walled pipelines. The inner pipe and the outer pipe as well as the connection flanges that are disposed at the ends of the pipeline portions are preferably made of metal, in order to ensure good weldability.

Since there is less and less room for assembly as well as due to the minimum distances that need to be kept to other technical devices, it is often necessary to lay out the above-described pipelines for supplying fuel to the trimming tank and to the auxiliary power unit, at least in portions, in a curved manner. However, curved, double-walled pipeline portions, in particular made of titanium or aluminum, can only be manufactured at high cost, since titanium as well as aluminum can only be welded in an inert gas atmosphere in a welding chamber.

The inner pipe for forming the double-walled pipeline can be bent comparatively easily and thus adjusted to the structurally required curvature radii. At least in the curved pipeline portions (and depending on the curvature radius and the size of the distance between the inner pipe and the outer pipe), the outer pipe to be disposed around the inner pipe can be slid only within a limited length over the inner pipe without becoming stuck, so that in order to form a longer curved double-walled pipeline portion, a plurality of curved outer pipeline portions have to be welded together. Due to the limited size of welding chambers and the limited manageability of larger curved pipeline portions in the welding chamber, it is therefore only possible to manufacture comparatively short curved double-walled pipeline portions for example of titanium.

These comparatively short curved pipeline portions in turn need to be connected to each other by flange joints, which increase the weight, in order to form longer pipelines or pipeline portions. On the one hand, the comparatively large number of additional flange joints leads to higher maintenance costs, since the leak tightness of the flange joints has to be monitored constantly. On the other hand, also the weight of the entire pipeline increases due to the flange joints.

It is therefore an object of the present invention to provide a pipeline for fuel systems in aircraft that is double-walled and thus in accordance with all relevant security standards of international aviation authorities, that includes fewer maintenance-intensive and weight-increasing flange joints even in the case of a plurality of long curved portions to be laid out, and that is moreover easy to manufacture.

This object is solved by a pipeline with the features of claim 1.

Due to the fact that the inner pipe is made of a metal material and/or at least in portions of a synthetic material and that the outer pipe is made of a synthetic material at least in curved portions of the pipeline, the manufacture of a pipeline in accordance with the invention in curved portions is simplified considerably by reducing the number of necessary welding joints. Furthermore, in particular in longer curved portions, an inventive pipeline can be manufactured substantially without flange joints, so that the total number of necessary flange joints is reduced considerably in comparison to known double-walled fuel pipelines made of titanium, which results in a significant weight reduction.

Furthermore, using a synthetic material to form the outer pipe in straight portions of the inventive pipeline as well makes it possible to save weight.

By using a synthetic material, at least in portions, also for the inner pipe, it is possible to reduce the weight even further. In this case, the synthetic material is preferably fire proof or refractory.

In a preferable embodiment of the inventive pipeline, at least one spacer is arranged between the inner pipe and the outer pipe. This embodiment ensures a precisely defined cavity or a constant spacing in radial direction between the inner pipe and the outer pipe. The spacers are preferably formed similar to snappable or snap-on cables ties, so that they can be used universally for inner pipes of different diameters and/or cross-sectional shapes and furthermore can be firmly placed on them. The spacers may, however, also have a structure that is different to this.

In accordance with a further preferable embodiment, the inner pipe and the outer pipe have a substantially annular cross-sectional shape. This ensures that the pipeline has high mechanical stability and moreover is easy to manufacture.

In accordance with a further preferable embodiment of the inventive pipeline, the inner pipe is arranged substantially coaxially within the outer pipe. This leads to advantageous flow conditions within the cavity formed between the inner pipe and the outer pipe.

In accordance with a further preferable embodiment of the pipeline, the inner pipe is made of aluminum, stainless steel or titanium. In particular, an inner pipe made of titanium ensures very high mechanical rigidity while having a low weight.

In accordance with a further preferable embodiment, the synthetic material constituting the outer pipe is a fiber-reinforced thermosetting synthetic material, in particular a carbon-fiber-reinforced epoxy resin. The outer pipe is preferably made of a carbon-fiber-reinforced epoxy resin, in particular a so-called “prepreg material”. A prepreg material is a fabric, fiber laminate or the like, which already has been impregnated with an epoxy resin, polyester resin or a phenolic resin. The prepreg material is stored in a cool environment in order to avoid curing. The final curing of the prepreg material is carried out after shaping in an autoclave, which ensures an optimal pressure and temperature curve during the curing process. Alternatively, the fiber reinforcement of the synthetic material may also be accomplished with glass fibers, aramid fibers or other mechanically strong fibers.

In accordance with a further preferable embodiment of the invention, the inner pipe is made, at least in portions, of a fiber-reinforced thermosetting synthetic material, in particular a refractory carbon-fiber-reinforced epoxy resin. By using, at least in portions, such a synthetic material for the inner pipe, a further weight reduction becomes possible. In this case, a fire-resistant or refractory carbon-fiber-reinforced epoxy resin material is used for the inner pipe.

The object is also solved by a method with the features of claim 8.

An inventive method for manufacturing a pipeline comprising an inner pipe and an outer pipe surrounding the inner pipe includes the following steps:
attaching flange joints to both pipe ends of the inner pipe as well as at least one spacer on the inner pipe;
arranging a supporting core on the inner pipe; and
placing a synthetic material on the supporting core in order to form the outer pipe on the supporting core.

In accordance with the inventive method, it is possible to manufacture the pipeline, in particular the curved portions of the pipeline, in an easy manner. Furthermore, using a fiber-reinforced synthetic material to form the outer pipe, not only makes it possible to form longer curved pipeline portions, but also leads to a considerable weight reduction. Only the placing of flange joints onto the ends of the inner pipe, which is preferably made of titanium, is carried out in a conventional manner within a welding chamber by thermowelding in an inert gas atmosphere. Alternatively, it is also possible to press on or screw on the flange joints. The formation of the outer pipe is performed in a simple manner by providing an easily shapeable and curable synthetic material, in particular a carbon-fiber-reinforced epoxy resin (“prepreg material”) or the like, on a support core disposed on the inner pipe. After removing the support core and optional reworking, the pipeline manufactured in accordance with the inventive method is ready to be built in. Alternatively, it is also possible to use for example cured half-shells made of such a prepreg material as the support core, wherein the half-shells form the inner surface of the outer pipe after curing the synthetic material provided from the outside, and thus remain inside the pipeline.

It is also possible to make the inner pipe from a synthetic material. In this case, it is preferable to use a fire resistant or refractory carbon-fiber-reinforced epoxy resin material.

Further preferable embodiments of the inventive pipeline and the inventive method are specified in the other claims.

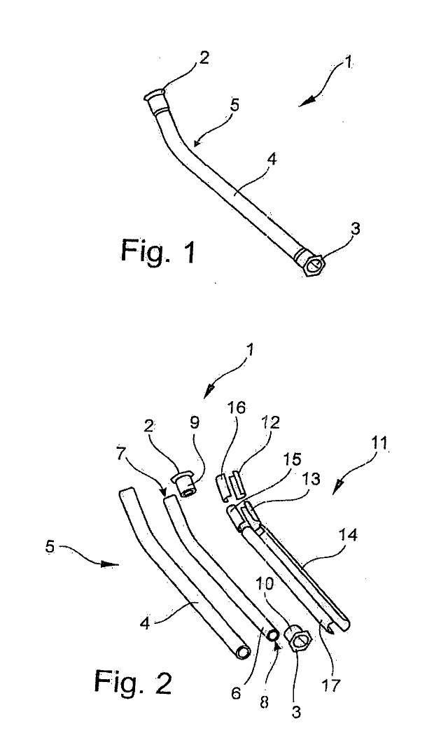

FIG. 1 shows a perspective view of an inventive pipeline.

FIG. 2 shows a perspective view of the internal configuration of the pipeline shown in FIG. 1.

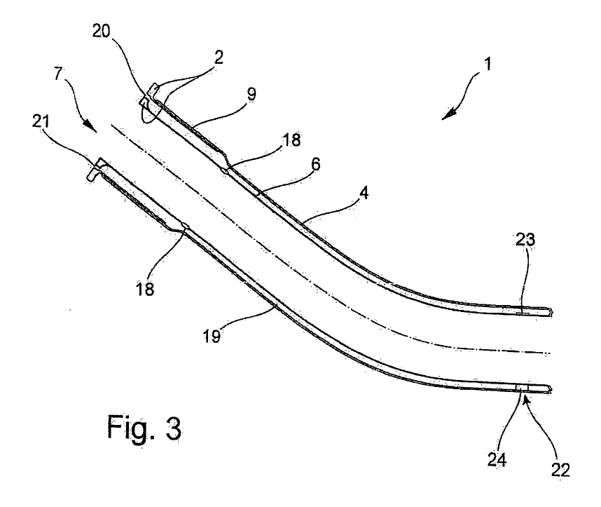

FIG. 3 shows a longitudinal sectional view of an inventive pipeline.

Unless noted otherwise, like structural elements in the drawings are denoted by like reference numerals.

FIG. 1 shows a perspective view of an embodiment of an inventive pipeline 1 for a fuel system in an aircraft. The pipeline 1 is in particular for connecting the main tanks of the aircraft, which are disposed in the wings, with a trimming tank disposed in the horizontal stabilizer as well as with a turbine-powered auxiliary power unit for supplying power to the on-board electrical system and the air conditioning, the auxiliary power unit being disposed in the tip of the stern.

The pipeline 1 comprises flange joints 2 and 3 on both of its ends. The flange joints 2 and 3 are for connecting or joining the pipeline 1 with further pipelines or pipeline portions (not shown in the drawings) in order to form a longer pipeline. An outer pipe 4 surrounds an inner pipe (not shown in FIG. 1) preferably substantially coaxially. In accordance with the invention, the outer pipe 4 is made of a fiber-reinforced synthetic material, in particular a prepreg material of a carbon-fiber-reinforced epoxy resin. Alternatively, it is also possible to use glass fibers, aramid fibers or other mechanically strong fibers for the purpose of fiber reinforcement. The outer pipe 4 comprises a curved portion 5, which can be fabricated comparatively easily due to using an outer pipe 4 that is made of a fiber-reinforced synthetic material. The pipeline 1 can have a geometric shape that is different from that shown in FIG. 1, and may have virtually any geometric shape.

The pipeline 1 can be regarded as part of a longer pipeline for a fuel system within an aircraft, which connects for example the wing tanks with a trimming tank and/or with a turbine-powered auxiliary power unit for the on-board electrical system. For this purpose a plurality of pipelines are connected by flange joints to a longer pipeline, which can have an overall very complex spatial configuration.

FIG. 2 is a perspective view of the internal configuration of the pipeline shown by way of example in FIG. 1, which comprises a support core that is used only for its manufacture. Referring to FIG. 2, the internal configuration of the pipeline as well as an inventive method for manufacturing it are described in the following.

The flange joints 2 and 3 are welded on at the inner pipe ends 7 and 8 of an inner pipe 6, which is bent in a curved portion 5. The outer pipe 4 is formed only after joining the flange joints 2 and 3 to the inner pipe 6. The inner pipe 6 is made of a metal material, such as aluminum, titanium or stainless steel. The inner pipe 6 and the outer pipe 4 each have a substantially circular cross-sectional shape. In order to ensure good weldability to the inner pipe 6, the flange joints 2 and 3 are preferably made of the same material as the inner pipe 6.

In an alternative embodiment, in particular the outer pipe 4 may have a different geometric shape, such as an elliptic or oval cross-sectional shape, for example. In order to further reduce the weight, also the inner pipe 6 may be made of a synthetic material, in particular a fiber-reinforced thermosetting synthetic material. In this case the inner pipe is preferably made of a flame resistant or refractory carbon-fiber-reinforced epoxy resin material.

The outer pipe 4 surrounds the inner pipe 6 preferably coaxially, so that a cavity or gap is formed between the inner pipe 6 and the outer pipe 4. This double-walled configuration of the pipeline 1 has several functions. For example, in the event of a leakage of the inner pipe 6, it is possible to shunt fuel through the gap or cavity in a controlled manner to a drainage pipe, so that passengers are not endangered by fuel leakages in the area of the fuselage cell. Furthermore, it is possible to detect such leakages with sensors that are disposed in this gap.

In the region of the gap, the flange joints 2 and 3 comprise a plurality of passageways, in order to enable an unhindered flow of fuel. Furthermore, the flange joints 2 and 3 are provided with support surfaces for gaskets or sealings, wherein the gaskets or sealings also comprise cut-outs corresponding to the passageways. In order to attain a reliable and mechanically strong connection of the outer pipe 4 to the flange joints 2 and 3, the flange joints 2 and 3 each comprise a contact surface 9 or 10. The contact surfaces 9 and 10 can be provided with a primer, adhesive agent, at least partial roughening or the like in order to accomplish a better connection of the outer pipe 4.

In order to manufacture a pipeline in accordance with the inventive method, first, a sufficiently long pipe portion of a semi-finished pipe made of aluminum, titanium or stainless steel or the like is cut to a suitable length in order to form the inner pipe 6. The inner pipe 6 is preferably made of titanium. Subsequently, the inner pipe 6 may be provided with the geometric shape in accordance with the structural requirements by bending. In order to form inner pipes 6 of larger length, it is also possible to weld together several shorter pipe portions. The welding of the pipe portion is preferably performed after any bending that may be necessary. After this, the flange joints 2 and 3 are welded to both inner pipe ends 7 and 8 of the inner pipe 6 in a welding chamber by a conventional method under an inert gas atmosphere. Alternatively, the flange joints 2 and 3 may also be pressed on, welded on or fixed by any other method to the inner pipe ends 7 and 8. The flange joints 2 and 3 furthermore comprise the contact surfaces 9 and 10 for connection to the outer pipe 4, which is made of the fiber-reinforced synthetic material.

After the fabrication of the inner pipe 6 has been completed, spacers (not shown in FIG. 2) are placed on the inner pipe 6. Herein, it is preferable to place several spacers that are offset to each other with a certain spacing along the longitudinal direction of the inner pipe 6 around the circumference of the inner pipe 6. The spacers ensure that a predetermined spacing is kept between the inner pipe 6 and the outer pipe 4.

After this, a support core 11 is placed on the inner pipe 6. The areas of the contact surfaces 9 and 10, which are in particular for the connection of the outer pipe 4, stay free. In the embodiment shown in FIG. 2, the support core 11 is made of a total of six half shells 12 to 17 of a synthetic material that can be easily dissolved or removed chemically and/or thermally, such as Styrofoam™ or the like. The half shells 12 to 17 have an outer shape that makes it possible to place them snugly on the corresponding pipeline portions of the inner pipe 6. The wall thickness of the half shells 12 to 17 corresponds to the spacing to be provided between the inner pipe 6 and the outer pipe. In order to minimize manufacturing costs, the support core 11 is preferably made of a limited number of standardized half shells 12 to 17, so that the half shells 12 to 17 typically do not have to be adjusted individually to the respective geometric shape of the inner pipe 6.

To form the support core 11, it is possible to use synthetic materials that melt at low temperatures, wax-like substances such as waxes, forming sands or any other material that can be easily removed.

Subsequently, the outer pipe 4 on the support core 11 is made by wrapping a prefabricated fiber-reinforced epoxy resin material, in particular a prepreg material, which is finally cured. Herein, also the contact surfaces 9 and 10 for the connection to the outer pipe 4 are wrapped at the same time. Alternatively, it is also possible to wrap rovings of carbon fibers, glass fibers, aramid fibers or the like around the inner pipe 6, impregnating the rovings with a curable synthetic material, in particular with an epoxy resin or a polyester resin, and then curing them. Instead of the roving wrappings, it is also possible to use areal structures of carbon fibers, glass fibers, aramid fibers or the like, such as fabrics or laminates. Also a combination of rovings and areal structures can be used to form the fiber reinforcement of the outer pipe 4.

After the curing of the outer pipe 4, the support core 11 made of the half shells 12 to 17 of Styrofoam™, is removed, for example by rinsing with a chemical solvent that dissolves or decomposes the Styrofoam™. The half shells 12 to 17 can also be made of a different synthetic material, which can be removed by heating, for example. Alternatively, the half shells 12 to 17 may also be made of a different synthetic material that is not easily dissolved or removed chemically and/or thermally.

In an alternative method, the support core 11 may be made of half shells 12 to 17 of a fiber-reinforced epoxy resin. After wrapping the prepreg material around the support core 11 formed in this manner, the support core 11 itself then forms a part of the outer pipe 4, that is, the support core 11 is not removed after curing the prepreg material. The half shells 12 to 17 also may be made of a different synthetic material, however it is preferable to ensure that the synthetic material used to form the outer pipe 4 has good adhesiveness, since a support core 11 formed in this manner cannot be removed.

Instead of using the half shells 12 to 17, it is also possible to assemble the support core 11 from other geometric basic shapes. Furthermore, at least in portions, the support core 11 may have an outer shape that is not circular, for example in order to provide the outer pipe 4 with a square or rectangular outer shape. Accordingly, also the inner pipe 6 may have a cross-sectional shape that is not circular, in which case the inner surface of the support core 11 has to be adapted accordingly, in order to ensure that the support core 11 is supported over its entire area by the inner pipe 6.

FIG. 3 shows a longitudinal section of an end portion of an inventive pipeline.

In the region of the end 7 of the inner pipe, the flange joint 2 is connected to the inner pipe 6 by a circumferential welding seam 18. The outer pipe 4 surrounds the inner pipe 6 substantially coaxially. The outer pipe 4 is connected firmly to the contact surface 9. The connection between the outer pipe 4 and the contact surface 9 is accomplished by adhering or gluing in the course of the wrapping of the prepreg material around the support core (which is not shown in FIG. 3). Due to the substantially coaxial arrangement, there is a spacing 19 between the inner pipe 6 and the outer pipe 4, which enables the controlled shunting of fuel in the case of damages or accidents. Furthermore, the flange joint 2 comprises a plurality of cut-outs 20 and 21, which enable the passing of fuel to a further pipeline (not shown in the drawings) that is connected to the flange joint 2. In order to make the spacing 19, if possible, substantially constant over the entire course of the pipeline 1, at least one spacer 22 is provided. The spacer 22 is made of a fixing strip 23, on one end of which a spacer piece 24 is placed. Similar to a cable tie, the fixing strip 23 can be introduced in a snappable manner into the spacer piece 24, so that the spacer 22 can be attached universally onto different inner pipes 6 of different diameters and/or cross-sectional shapes. For this purpose, the fixing strip 23 has a length that is slightly longer than the circumference of the inner pipe.

### LIST OF REFERENCE NUMERALS

1 pipeline
2 flange joint
3 flange joint
4 outer pipe
5 curved portion
6 inner pipe
7 inner pipe end
8 inner pipe end
9 contact surface
10 contact surface
11 support core
12 half shell
13 half shell
14 half shell
15 half shell
16 half shell
17 half shell
18 welding seam
19 spacing
20 cut-out
21 cut-out
22 spacer
23 fixing strip
24 spacer piece

What is claimed is:

1. A pipeline comprising an inner pipe and an outer pipe surrounding the inner pipe,
wherein the inner pipe is made of a metal material and/or, at least in portions, of a synthetic material and that, at least in curved portions of the pipeline, the outer pipe is made of a synthetic material.

2. The pipeline according to claim 1,
wherein at least one spacer is arranged between the inner pipe and the outer pipe.

3. The pipeline according to claim 1,
wherein the inner pipe and the outer pipe have a substantially annular cross-sectional shape.

4. The pipeline according to claim 1,
wherein the outer pipe is arranged substantially coaxially to the inner pipe.

5. The pipeline according to claim 1,
wherein the inner pipe is made of at least one selected from the group of aluminum, stainless steel and titanium.

6. The pipeline according to claim 1,
wherein the synthetic material constituting the outer pipe is a fiber-reinforced thermosetting synthetic material.

7. The pipeline according to claim 6,
wherein the synthetic material constituting the outer pipe is a carbon-fiber-reinforced epoxy resin.

8. The pipeline according to claim 1,
wherein the inner pipe is made, at least in portions, of a fiber-reinforced thermosetting synthetic material.

9. The pipeline according to claim 8,
wherein the inner pipe is made, at least in portions, of a refractory carbon-fiber-reinforced epoxy resin.

10. The pipeline according to claim 1, wherein the pipeline is a pipeline for a fuel system in an aircraft.

11. A method for manufacturing a pipeline according to claim 1, comprising an inner pipe and an outer pipe surrounding the inner pipe, the method comprising the following steps:
attaching flange joints to both inner pipe ends of the inner pipe as well as at least one spacer on the inner pipe;
arranging a supporting core on the inner pipe; and
placing a synthetic material on the supporting core in order to form the outer pipe.

12. The method according to claim 11,
wherein the inner pipe is made of a metal material and/or, at least in portions, of a synthetic material.

13. The method according to claim 12,
wherein the inner pipe is made of at least one of stainless steel, titanium or aluminum.

14. The method according to claim 11,
wherein the flange joints are welded or pressed on the inner pipe.

15. The method according to claim 11,
wherein the outer pipe is made of a fiber-reinforced thermosetting resin material

16. The method according to claim 15,
wherein the outer pipe is made of a carbon-fiber-reinforced epoxy resin.

17. The method according to claim 11,
wherein the inner pipe is made of a fiber-reinforced thermosetting synthetic material.

18. The method according to claim 17,
wherein the inner pipe is made of a refractory carbon-fiber-reinforced epoxy resin.

19. The method according to claim 11,
wherein the supporting core is made of half shells, and wherein the half shells are made of a synthetic material.

20. The method according to claim 19,
wherein the half shells are made of a synthetic material that can be easily dissolved chemically and/or thermally.

21. The method according to claim 11,
wherein the supporting core is made of half shells, and wherein the half shells are made of a fiber-reinforced thermosetting synthetic material.

22. The method according to claim 21,
wherein the half shells are made of carbon-fiber-reinforced epoxy resin.
